(19) United States
(12) Patent Application Publication
(10) Pub. No.: US 2020/0057407 A1
(43) Pub. Date: Feb. 20, 2020

(54) IMAGE FORMING APPARATUS

(71) Applicant: KYOCERA Document Solutions Inc., Osaka (JP)

(72) Inventor: Takuya FUKATA, Osaka-shi (JP)

(73) Assignee: KYOCERA Document Solutions Inc., Osaka (JP)

(21) Appl. No.: 16/536,619

(22) Filed: Aug. 9, 2019

(30) Foreign Application Priority Data
Aug. 16, 2018 (JP) 2018-153168

(51) Int. Cl. G03G 15/00

(52) U.S. Cl. CPC G03G 15/556; G03G 2215/0697; G03G 2215/0888; G03G 15/5016

(57) ABSTRACT

An image forming apparatus includes an attachment section, an intermediate hopper, second storage, an image forming section, a first calculation section, and a second calculation section. The image forming section forms an image on a sheet using the toner contained in the intermediate hopper. The first calculation section, in a case where an image is to be formed on a first predetermined number of the sheets, calculates a consumed toner amount that is the amount of toner consumed during formation of the image on a second predetermined number of the sheets, the second predetermined number being smaller than the first predetermined number. The second calculation section calculates the maximum number of the sheets on which the image can be formed, on the basis of the consumed toner amount, the first toner amount, and the second toner amount.

### INCORPORATION BY REFERENCE

The present application claims priority under 35 U.S.C. § 119 to Japanese Patent Application No. 2018-153168, filed on Aug. 16, 2018, the entire disclosure of which is incorporated herein by reference.

### BACKGROUND

The present disclosure relates to image forming apparatuses.

An image forming apparatus has a toner container attached thereto. When no toner is left in the toner container, the toner container is replaced. In some image forming apparatuses, even when the toner container has been detached, a print job (printing) is not suspended. For example, some image forming apparatuses have a detector that detects attachment and detachment of the toner container. In some image forming apparatuses, when the detector determines that the toner container has been detached, a print job is continued and the user is prompted to attach a toner container soon.

### SUMMARY

An image forming apparatus according to the present disclosure includes an attachment section, an intermediate hopper, second storage, an image forming section, a first calculation section, and a second calculation section. A toner container having first storage configured to store a first toner amount of toner contained in the toner container is detachably attached to the attachment section. The intermediate hopper accommodates the toner supplied from the toner container. The second storage stores a second toner amount of the toner contained in the intermediate hopper. The image forming section forms an image on a sheet using the toner contained in the intermediate hopper. The first calculation section, in a case where an image is to be formed on a first predetermined number of the sheets, calculates a consumed toner amount that is the amount of toner consumed during formation of the image on a second predetermined number of the sheets, the second predetermined number being smaller than the first predetermined number. The second calculation section calculates the maximum number of the sheets on which the image can be formed, on the basis of the consumed toner amount, the first toner amount, and the second toner amount.

### BRIEF DESCRIPTION OF THE DRAWINGS

FIG. 1 is a diagram illustrating a configuration of an image forming apparatus according to an embodiment of the present disclosure.

FIG. 2 is a block diagram illustrating the configuration of the image forming apparatus according to the embodiment.

FIG. 3 is a diagram illustrating an example of an introduction section, an intermediate hopper, and a developing device according to the embodiment.

FIG. 4 is a diagram illustrating an example of a display screen according to the embodiment.

FIG. 5 is a diagram illustrating an example of a display screen according to the embodiment.

FIG. 6 is a flowchart illustrating a main routine of a control device according to the embodiment.

FIG. 7 is a flowchart illustrating a sub-routine of the control device according to the embodiment.

### DETAILED DESCRIPTION

An embodiment of the present disclosure will now be described with reference to the accompanying drawings. Note that the same or corresponding parts are designated by the same reference signs throughout the several views, and will not be redundantly described.

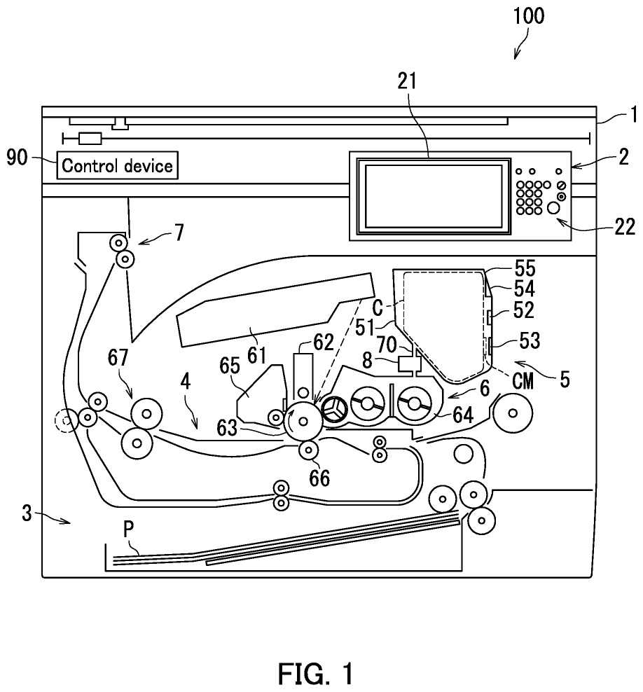

Firstly, a configuration of an image forming apparatus 100 according to the present embodiment will be described with reference to FIG. 1. FIG. 1 is a diagram illustrating the configuration of the image forming apparatus 100 of the present embodiment. In the present embodiment, the image forming apparatus 100 is a multifunction peripheral. The image forming apparatus 100 of the present embodiment forms an image in a monochromatic fashion.

The image forming apparatus 100 includes a housing 1, an operation section 2, a paper feed section 3, a conveyance section 4, a replenishment section 5, an image forming section 6, an ejection section 7, an intermediate hopper 8, an introduction section 70, and a control device 90. The paper feed section 3, the conveyance section 4, the replenishment section 5, the image forming section 6, the ejection section 7, the intermediate hopper 8, the introduction section 70, and the control device 90 are disposed inside the housing 1.

The operation section 2 includes a touch display 21 and a plurality of operation keys 22. The touch display 21 includes a display and a touch sensor. The touch display 21 is an example of a display section and an input section.

The display shows various screens. These screens include a standby screen. The standby screen contains, for example, a menu button for instructing to execute various processes. The display is, for example, a liquid crystal display or an organic electroluminescent (EL) display.

The touch sensor detects a touch performed by an object to be detected. The touch sensor outputs a detection signal indicating a position where a touch has been detected. The object to be detected is, for example, a user's finger. The touch sensor is, for example, a resistive touch sensor. The plurality of operation keys 22 include, for example, a numeric keypad, a start key, and a cancel key.

The paper feed section 3 feeds paper P sheet by sheet. Paper P is an example of a sheet. Specifically, the paper feed section 3 includes a paper feed cassette and a group of paper feed rollers. The paper feed cassette accommodates a plurality of sheets of paper P. The paper feed cassette accommodates any type of paper P. The types of paper P include, for example, plain paper, cardboard, and calendered paper.

The group of paper feed rollers feeds a plurality of sheets of paper P loaded in the paper feed cassette, sheet by sheet.

The conveyance section 4 conveys paper P from the paper feed section 3 to the ejection section 7 through the image forming section 6.

The image forming section 6 executes an image forming process (printing). Specifically, the image forming section 6 forms an image on paper P using toner. In the present embodiment, the image forming section 6 includes a light exposure device 61, a charger 62, a photosensitive drum 63, a developing device 64, a cleaning device 65, a transfer roller 66, and a fixing device 67. The image forming section 6 forms an image in an electrophotographic fashion.

The light exposure device 61 forms an electrostatic latent image on the photosensitive drum 63 on the basis of image data. The charger 62 uniformly charges the photosensitive drum 63 to a predetermined potential.

The developing device 64 has a development container, a stirring member, and a development roller. The stirring member and the development roller are disposed inside the development container. The stirring member stirs toner supplied from the replenishment section 5 to the development container. The development roller supplies toner to the photosensitive drum 63 to develop an electrostatic latent image formed on the photosensitive drum 63.

The cleaning device 65 recovers toner adhering to the surface of the photosensitive drum 63.

The transfer roller 66 is disposed facing the photosensitive drum 63 to form a transfer nip. When paper P is passed through the transfer nip, a toner image formed on the surface of the photosensitive drum 63 is transferred to the paper P.

The fixing device 67 fixes a toner image transferred to paper P, to the paper P.

The ejection section 7 ejects paper P carrying an image formed thereon, out of the housing 1.

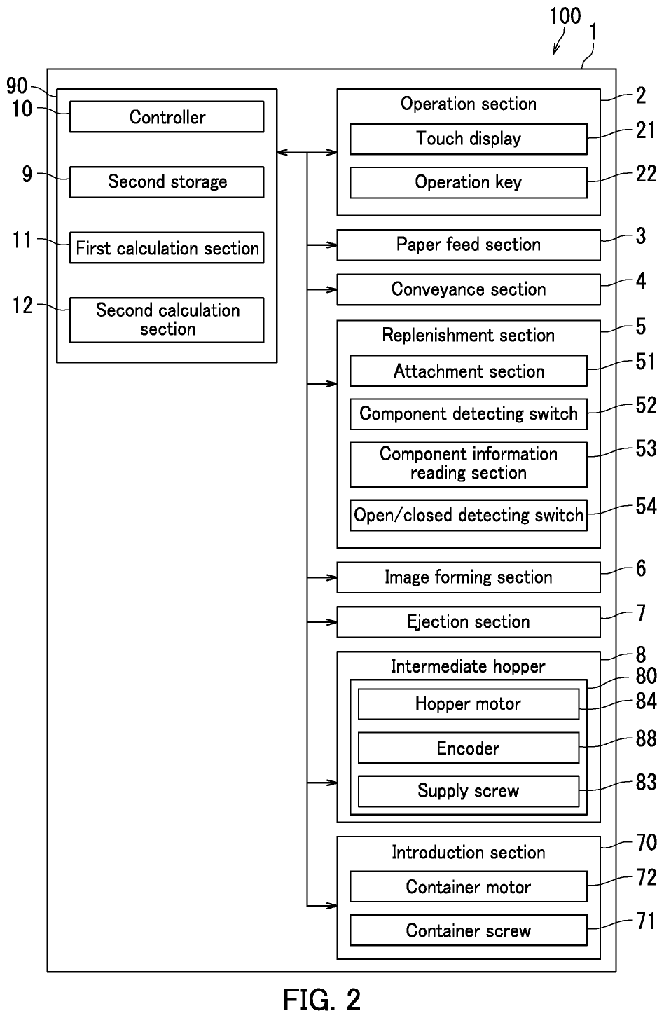

Next, the configuration of the image forming apparatus 100 of the present embodiment will be further described with reference to FIG. 2. FIG. 2 is a block diagram illustrating a configuration of the image forming apparatus 100 of the present embodiment. As illustrated in FIG. 2, the control device 90 includes second storage 9, a controller 10, a first calculation section 11, and a second calculation section 12.

The second storage 9 stores various pieces of data. The second storage 9 is implemented by a storage device and semiconductor memory. The storage device includes, for example, either or both of a hard disk drive (HDD) and a solid-state device (SSD). The semiconductor memory includes, for example, random access memory (RAM) and read only memory (ROM).

The various pieces of data include, for example, a control program for controlling the operation of each component of the image forming apparatus 100, and a first time it takes for the image forming section 6 to form an image on a sheet of paper P.

The controller 10, the first calculation section 11, and the second calculation section 12 are implemented by a processor such as a central processing unit (CPU). Alternatively, the controller 10, the first calculation section 11, and the second calculation section 12 are implemented by an integrated circuit for the image forming process. The integrated circuit for the image forming process includes, for example, an application specific integrated circuit (ASIC). The controller 10, the first calculation section 11, and the second calculation section 12 control the operation of each component of the image forming apparatus 100 by executing a control program.

The replenishment section 5 supplies toner to the image forming section 6. The replenishment section 5 includes an open/closed detecting switch 54, an attachment section 51, a component detecting switch 52, and a component information reading section 53. The component detecting switch 52 is an example of a detector.

The open/closed detecting switch 54 detects whether a cover member 55 is open or closed. The cover member 55 forms a portion of the wall of the housing 1 when the cover member 55 is closed. When the cover member 55 is closed, the open/closed detecting switch 54 outputs, to the controller 10, a signal indicating the closed state of the cover member 55. Meanwhile, when the cover member 55 is open, the attachment section 51 is exposed.

The component detecting switch 52 outputs, to the controller 10, a signal indicating whether or not a toner container C is attached to the attachment section 51.

The toner container C, which is replaceable, is detachably attached to the attachment section 51. A user can replace the toner container C with the cover member 55 open. The toner container C is an example of a replaceable component. The toner container C accommodates toner. Toner is an example of a consumable item.

The toner container C includes a storage element CM. The storage element CM is an example of first storage. The storage element CM is, for example, a contactless tag (electronic tag), such as a radio-frequency identification (RF) tag. The storage element CM stores information about the toner container C. The information about the toner container C is hereinafter referred to as “toner container information.”

The toner container information contains, for example, a cumulative toner supply amount X, and a full toner accommodation amount XF. The cumulative toner supply amount X is the cumulative value of the toner supply amount of toner that has been supplied to the intermediate hopper 8 since the toner container C was attached to the attachment section 51 and until the toner container C is detached from the attachment section 51.

The component information reading section 53 reads the toner container information from the storage element CM, and outputs a signal indicating the toner container information to the controller 10. The component information reading section 53 is, for example, a short-range wireless communication device, such as an RF reader.

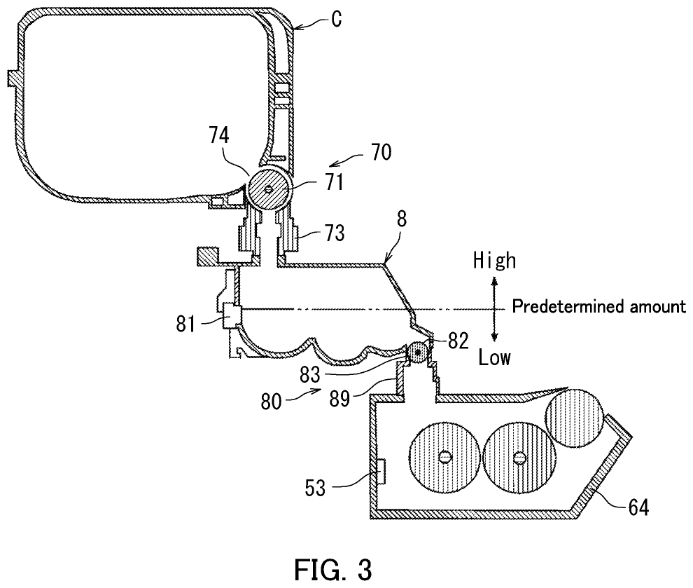

Next, members involved in toner supply and a procedure for toner supply in the present embodiment will be described with reference to FIGS. 2 and 3. FIG. 3 is a diagram illustrating an example of the introduction section 70, the intermediate hopper 8, and the developing device 64 of the present embodiment.

The introduction section 70 includes a container screw 71 and a container motor 72. The container screw 71 has, for example, a helical blade wrapped around a rotating shaft. The container screw 71 is provided below the toner container C, facing an opening 74 of the toner container C. The container motor 72 rotates the container screw 71. By the rotation of the container screw 71, toner is introduced from the toner container C into the intermediate hopper 8.

The component information reading section 53 updates the cumulative toner supply amount X stored in the storage element CM according to an instruction from the controller 10. For example, the component information reading section 53 calculates the toner amount x of toner. The component information reading section 53 accumulates the toner amount x in the cumulative toner supply amount X stored in the storage element CM to update the cumulative toner supply amount X. The toner amount x is the toner amount of toner that is supplied to the intermediate hopper 8 by the container screw 71 being rotated one turn.

The intermediate hopper 8 includes an introduction pipe 73 and an output portion 80. The introduction pipe 73 links the introduction section 70 and the intermediate hopper 8 together. Toner passes through the introduction pipe 73.

The output portion 80 includes a remaining amount sensor 81, a toner outlet 82, a supply screw 83, a hopper motor 84, a supply pipe 89, and an encoder 88. The remaining amount sensor 81 is, for example, a piezoelectric sensor. The remaining amount sensor 81 is provided in a side wall of the intermediate hopper 8 so as to be in contact with toner in the intermediate hopper 8. The remaining amount sensor 81 detects whether or not a predetermined amount of toner is present in the intermediate hopper 8 (whether or not the intermediate hopper 8 is filled with toner). Specifically, a portion of the remaining amount sensor 81 that is exposed to the inside of the intermediate hopper 8 is being vibrated. When toner is in contact with such a portion, the vibration of the remaining amount sensor 81 is altered. The output of the remaining amount sensor 81 varies depending on a change in the vibration.

For example, in FIG. 3, when the intermediate hopper 8 is filled with toner to a level indicated by a dash-dot-dot line, the remaining amount sensor 81 outputs a high-level signal. The level indicated by the dash-dot-dot line corresponds to the above predetermined amount. Meanwhile, in FIG. 3, when toner is reduced below the level indicated by the dash-dot-dot line, the remaining amount sensor 81 outputs a low-level signal.

When the remaining amount sensor 81 outputs the low-level signal, the controller 10 determines that the toner amount of toner remaining in the intermediate hopper 8 is smaller than the predetermined amount. The controller 10 actuates the container motor 72 to introduce toner into the intermediate hopper 8. Meanwhile, when the remaining amount sensor 81 outputs the high-level signal, the controller 10 determines that the toner amount of toner remaining in the intermediate hopper 8 is greater than or equal to the predetermined amount. The controller 10 stops the operation of the container motor 72.

The toner outlet 82 is provided at a lower end of the intermediate hopper 8 and is coupled to the developing device 64. The supply screw 83 is provided with, for example, a helical blade wrapped around a rotating shaft. The supply screw 83 is provided at an entrance portion of the toner outlet 82. The hopper motor 84 rotates the supply screw 83. By the rotation of the supply screw 83, toner is introduced from the intermediate hopper 8 to the developing device 64 through the supply pipe 89.

The encoder 88 is provided in relation to the supply screw 83 of the intermediate hopper 8. For example, the encoder 88 outputs one pulse when the supply screw 83 rotates one turn. The supply screw 83 introduces substantially the same amount of toner into the developing device 64 each time the supply screw 83 rotates one turn. The amount of toner introduced into the developing device 64 each time the supply screw 83 rotates one turn is, for example, 10 milligrams to several tens of milligrams, and varies depending on the type of the supply screw 83. A toner supply amount Y from the intermediate hopper 8 to the developing device 64 is calculated on the basis of the number of turns of the supply screw 83.

The output of the encoder 88 is input to the controller 10. The controller 10 recognizes that the supply screw 83 has rotated one turn, so that a predetermined amount of toner has been supplied from the intermediate hopper 8 to the developing device 64. When the supply screw 83 rotates, the controller 10 calculates the toner supply amount Y from the intermediate hopper 8 to the developing device 64. The controller 10 stores, into the second storage 9, a second toner amount (=the cumulative toner supply amount X−the toner supply amount Y) in the intermediate hopper 8 obtained by subtracting the toner supply amount Y from the cumulative toner supply amount X stored in the storage element CM.

Note that the developing device 64 includes a development sensor 68. The development sensor 68 detects the need of toner supply when the amount of toner in the developing device 64 is small. The output of the development sensor 68 is input to the controller 10. The controller 10, when receiving the output of the development sensor 68, actuates the hopper motor 84 so that toner is supplied from the intermediate hopper 8 to the developing device 64. Note that a toner state in which even when the controller 10 continues to operate the hopper motor 84, the output of the development sensor 68 is input to the controller 10, is referred to as “toner empty.”

In the case where an image is to be formed on a first predetermined number of sheets of paper P, the first calculation section 11 calculates a consumed toner amount Z that is the amount of toner consumed when the image was formed on a second predetermined number of sheets of paper P. For example, the second predetermined number is the number of sheets of paper P in one set, i.e. five sheets. The first predetermined number is the number of sheets of paper P in a desired number of sets. For example, if the desired number of sets is 100 sets, the first predetermined number is 500 sheets. Thus, when the same image is formed on 100 sets of paper P, the amount of toner consumed for 100 sets can be exactly calculated by calculating the consumed toner amount Z that is the amount of toner consumed for one set. Therefore, the user performs, on the operation section 2, an input operation of preparing 100 sets each of which includes 5 sheets of paper P. The first calculation section 11, when receiving the input operation, initially causes the image forming apparatus 100 to form an image on one set of paper P. After the formation of the image on one set of paper P, the first calculation section 11 calculates the toner supply amount Y on the basis of the output of the encoder 88. The first calculation section 11 sets the toner supply amount Y as the consumed toner amount Z that is the amount of toner consumed when the image was formed on one set of paper P.

The second calculation section 12 calculates the maximum number of sets of paper P on which the image can be formed, on the basis of the consumed toner amount Z, the second toner amount (=the cumulative toner supply amount X−the toner supply amount Y), and a first toner amount (=the toner accommodation amount XF−the cumulative toner supply amount X). For example, when the first calculation section 11 calculates the consumed toner amount Z, the second calculation section 12 obtains the second toner amount (=the cumulative toner supply amount X−the toner supply amount Y) from the second storage 9. The second calculation section 12 also obtains the toner accommodation amount XF and the cumulative toner supply amount X from the storage element CM. The second calculation section 12 calculates the first toner amount (=the toner accommodation amount XF−the cumulative toner supply amount X) by subtracting the cumulative toner supply amount X from the toner accommodation amount XF. The second calculation section 12 also calculates the total amount of toner currently present in the image forming apparatus 100 (=the toner accommodation amount XF−the toner supply amount Y) by adding the second toner amount (=the cumulative toner supply amount X−the toner supply amount Y) and the first toner amount (=the toner accommodation amount XF−the cumulative toner supply amount X). The second calculation section 12 calculates the maximum number of sets of paper P on which the image can be formed, by dividing the total toner amount (=the toner accommodation amount XF−the toner supply amount Y) by the consumed toner amount Z.

The second calculation section 12 also calculates a second time on the basis of the second predetermined number, the maximum number of sets of paper P on which the image can be formed, and the first time stored in the second storage 9. The second time indicates a time it takes for the image forming section 6 to form the image on the maximum number of sheets of paper P on which an image can be formed. For example, in the case where the second predetermined number is 5 sheets, the maximum number of sets of paper P on which the image can be formed is 20 sets, and the first time is 0.2 seconds, the second time is 20 seconds.

The second calculation section 12 also causes the operation section 2 to display the maximum number of sets of paper P on which the image can be formed, and the second time. Therefore, the user can replace the toner container C with appropriate timing.

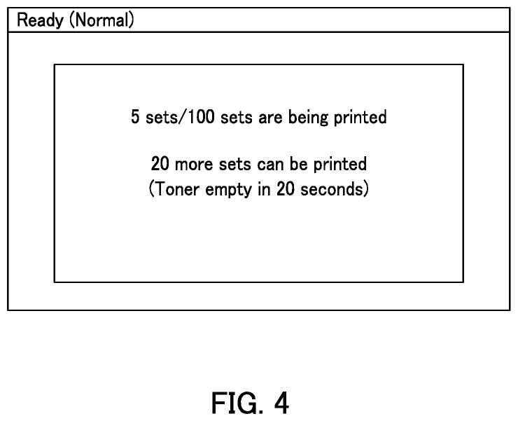

FIG. 4 is a diagram illustrating an example of a display screen according to the present embodiment. As illustrated in FIG. 4, the display screen displays a message indicating that “20 more sets can be printed.” The display screen also displays a message indicating that “Toner empty in 20 seconds.” The user, who has viewed the display screen, can recognize that the image cannot be formed on 100 sets of paper P, and the toner container C needs to be replaced.

Referring back to FIGS. 2 and 3, the members involved in toner supply and the procedure for toner supply in the present embodiment will be further described. The second calculation section 12 reduces the maximum number of sets of paper P on which the image can be formed each time the image is formed on one set of paper P. The second calculation section 12 causes the operation section 2 to display the reduced number of sets. For example, when the first calculation section 11 receives an input operation, the image forming section 6 forms the image on sheets of paper P one after another. For example, when the image is formed on 5 sets of paper P, a consumed toner amount of 5×Z is consumed. Therefore, the total toner amount (=the toner accommodation amount XF−the toner supply amount Y) is changed to the total toner amount (=the toner accommodation amount XF−the toner supply amount Y−the consumed toner amount of 5×Z). The maximum number of sets of paper P on which the image can be formed is also reduced by five. Therefore, the second calculation section 12 reduces the maximum number of sets of paper P on which the image can be formed. The second calculation section 12 causes the operation section 2 to display the reduced number of sets. The second calculation section 12 also reduces the second time each time the image is formed on a sheet of paper P. The second calculation section 12 causes the operation section 2 to display the reduced second time.

Furthermore, when the toner container C is replaced by a toner container C′, the second calculation section 12 recalculates the maximum number of sets of paper P on which the image can be formed. For example, the second calculation section 12 detects the replacement of the toner container C by the toner container C′ on the basis of the output of the component detecting switch 52. The second calculation section 12 obtains a toner accommodation amount XF′ and a cumulative toner supply amount X′ from a storage element CM′. The second calculation section 12 calculates a first toner amount (=the toner accommodation amount XF′−the cumulative toner supply amount X′) by subtracting the cumulative toner supply amount X′ from the toner accommodation amount XF′. The second calculation section 12 calculates the total toner amount of toner currently present in the image forming apparatus 100 (=the toner accommodation amount XF′−the cumulative toner supply amount X′+the cumulative toner supply amount X−the toner supply amount Y) by adding the second toner amount (=the cumulative toner supply amount X−the toner supply amount Y) and the first toner amount (=the toner accommodation amount XF′−the cumulative toner supply amount X′). The second calculation section 12 calculates the maximum number of sets of paper P on which the image can be formed, by dividing the total toner amount (=the toner accommodation amount XF′−the cumulative toner supply amount X′+the cumulative toner supply amount X−the toner supply amount Y) by the consumed toner amount Z.

The second calculation section 12 also calculates the second time on the basis of the second predetermined number, the maximum number of sets of paper P on which the image can be formed, and the first time stored in the second storage 9. For example, in the case where the second predetermined number is 5 sheets, the maximum number of sets of paper P on which the image can be formed is 20,000 sets, and the first time is 0.2 seconds, the second time is 300 minutes.

Thereafter, the second calculation section 12 causes the operation section 2 to display the maximum number of sets of paper P on which the image can be formed, and the second time.

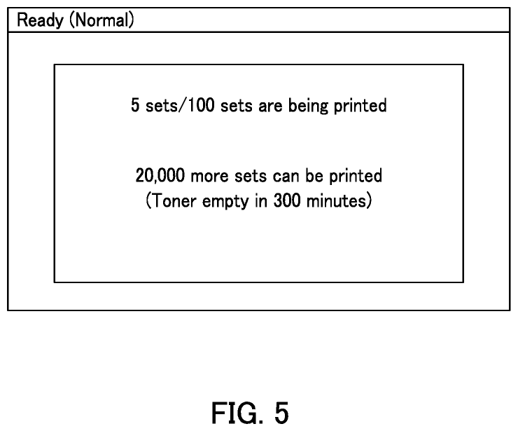

FIG. 5 is a diagram illustrating an example of a display screen according to the present embodiment. As illustrated in FIG. 5, the display screen displays a message indicating that “20,000 more sets can be printed.” The display screen also displays a message indicating that “Toner empty in 300 minutes.” The user, who has viewed the display screen, can recognize that the image can be formed on 100 sets of paper P using the toner container C′. The user can also recognize that the image will be formed on a large number of sheets of paper P, so that it takes time to form the image, and therefore, a problem will not arise when the user is away from the image forming apparatus 100 for 300 minutes. Furthermore, after the image has been formed on 100 sets of paper P, the toner container C′ may be replaced back by the toner container C if the toner container C′ has been used to form the image on a large number of sheets of paper P, and the toner container C has not been able to be used to form the image on a large number of sheets of paper P. Note that when a plurality of spare toner containers C′ are available, a toner container C′ for which the maximum number of sets of paper P on which the image can be formed is greater than the desired number of sets, is preferably selected for replacement.

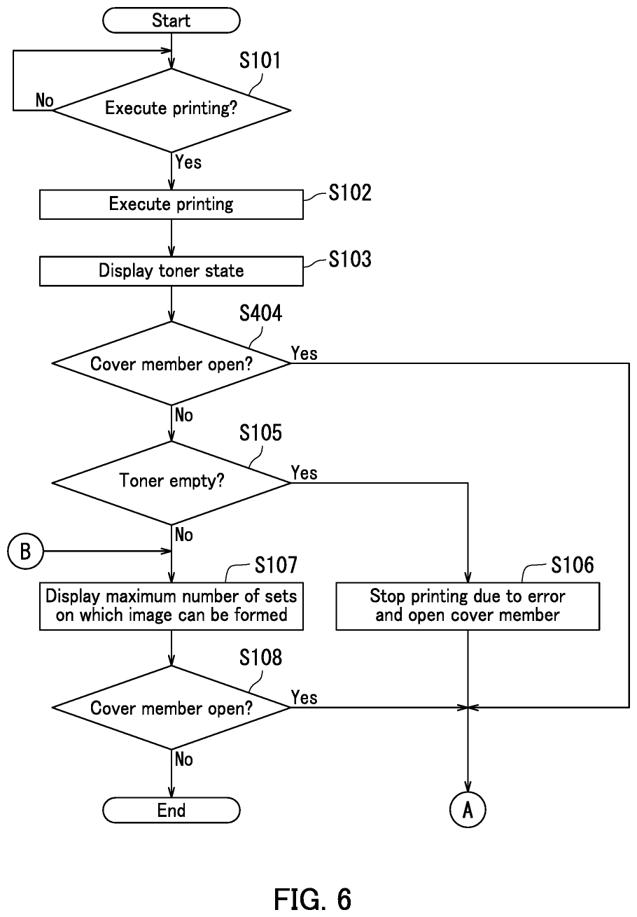

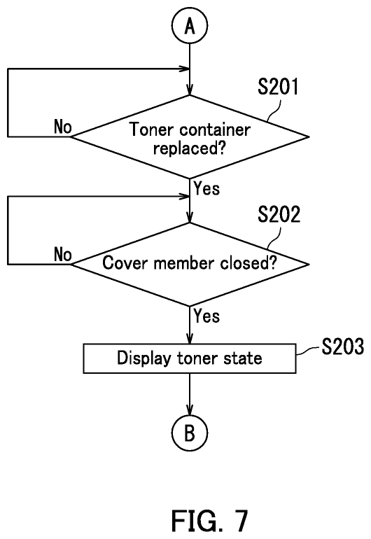

Next, a process of the control device 90 of the present embodiment will be described with reference to FIGS. 6 and 7. FIG. 6 is a flowchart depicting a main routine of the control device 90 of the present embodiment. FIG. 7 is a flowchart depicting a sub-routine of the control device 90 of the present embodiment. The process of the control device 90 includes steps S101-S107 and steps S201-S203.

As shown in FIG. 6, in step S101, the controller 10 determines whether or not to perform printing, on the basis of an input operation. The input operation indicates, for example, printing of a large number of sheets of paper P, particularly formation of an image on 100 sets of paper P where one set includes 5 sheets of paper P. When the controller 10 determines not to perform printing (No in step S101), the process is put into a standby state. Otherwise, i.e. when the controller 10 determines to perform printing (Yes in step S101), the process goes to step S102.

In step S102, the controller 10 performs printing. After the image is formed on one set of paper P, the first calculation section 11 calculates the consumed toner amount Z. After the printing, the process goes to step S103.

In step S103, the second calculation section 12 calculates the total toner amount (=the toner accommodation amount XF−the toner supply amount Y), and causes the operation section 2 to display the total toner amount (=the toner accommodation amount XF−the toner supply amount Y) as a toner state. After the total toner amount (=the toner accommodation amount XF−the toner supply amount Y) is displayed, the process goes to step S104.

In step S104, the controller 10 determines whether or not the cover member 55 is open, on the basis of the output of the open/closed detecting switch 54. When the controller 10 determines that the cover member 55 is open (Yes in step S104), the process goes to the sub-routine of FIG. 7. Otherwise, i.e. when the controller 10 determines that the cover member 55 is not open (No in step S104), the process goes to step S105.

In step S105, the controller 10 determines whether or not the toner state is toner empty, on the basis of the output of the development sensor 68. When the controller 10 determines that the toner state is toner empty (Yes in step S105), the process goes to step S106.

In step S106, the printing is stopped due to the toner empty error, and after the cover member 55 is opened, the process goes to the sub-routine of FIG. 7. Otherwise, i.e. when the controller 10 determines that the toner state is not toner empty (No in step S105), the process goes to step S107.

In step S107, the second calculation section 12 causes the operation section 2 to display the maximum number of sets of paper P on which the image can be formed, and the second time, on the basis of the consumed toner amount Z and the total toner amount. The user can determine whether or not to replace the toner container C, by viewing the maximum number of sets of paper P on which the image can be formed. The user can also determine whether or not a problem will arise when the user leaves the image forming apparatus 100, by viewing the second time. After the maximum number of sets of paper P on which the image can be formed, and the second time, are displayed, the process goes to step S108.

In step S108, the controller 10 determines whether or not the cover member 55 is open, on the basis of the output of the open/closed detecting switch 54. When the controller 10 determines that the cover member 55 is open (Yes in step S108), the process goes to the sub-routine of FIG. 7. Otherwise, i.e. when the controller 10 determines that the cover member 55 is not open (No in step S108), the process of the control device 90 of the present embodiment is ended.

Next, a process that is executed when the cover member 55 is open will be described. As shown in FIG. 7, initially, in step S201, the controller 10 stops the operation of the container motor 72, and determines whether or not the toner container C has been replaced, on the basis of the output of the component detecting switch 52. When the controller 10 determines that the toner container C has not been replaced (No in step S201), the process is put into the standby state. Otherwise, i.e. when the controller 10 determines that the toner container C has been replaced (Yes in step S201), the process goes to step S202.

In step S202, the controller 10 determines whether or not the cover member 55 is closed, on the basis of the output of the open/closed detecting switch 54. When the controller 10 determines that the cover member 55 is not closed (No in step S202), the process is put into the standby state. Otherwise, i.e. when the controller 10 determines that the cover member 55 is closed (Yes in step S202), the process goes to step S203.

In step S203, the second calculation section 12 calculates the total toner amount (=the toner accommodation amount XF′−the cumulative toner supply amount X′+the cumulative toner supply amount X−the toner supply amount Y), and causes the operation section 2 to display the total toner amount (=the toner accommodation amount XF′−the cumulative toner supply amount X′+the cumulative toner supply amount X−the toner supply amount Y) as a toner state. After the total toner amount (=the toner accommodation amount XF′−the cumulative toner supply amount X′+the cumulative toner supply amount X−the toner supply amount Y) is displayed, the process goes to step S107 of FIG. 6.

As described above with reference to FIGS. 1-7, in the present embodiment, the user can determine whether or not to replace the toner container C, by viewing the maximum number of sets of paper P on which an image can be formed. In addition, when an image will be formed on a large number of sheets of paper P, so that it takes time to complete the print job, the user can determine whether or not a problem will arise when the user leaves the image forming apparatus 100.

In the foregoing, an embodiment of the present disclosure has been described with reference to the drawings (FIGS. 1-7). Note that the present disclosure is not limited to the above-described embodiment, and may be applied to various alternative embodiments without departing the spirit and scope of the present disclosure (e.g., (1)-(3) below). The materials, shapes, dimensions, etc., of the components illustrated in the above-described embodiment are only for illustrative purposes and are not particularly limited, and may be changed and modified without substantially departing the configuration of the present disclosure.

(1) In the above-described embodiment, the second calculation section 12 causes the operation section 2 to display the maximum number of sets of paper P on which an image can be formed, and the second time. Note that the second calculation section 12 may cause the operation section 2 to display a message indicating whether or not an image can be formed on a predetermined number of sets of paper P. For example, when the desired number of sets is 100 sets, and the maximum number of sets of paper P on which an image can be formed is 20 sets, the second calculation section 12 causes the operation section 2 to display a message indicating that the image formation is not possible. Otherwise, i.e. when the desired number of sets is 100 sets, and the maximum number of sets of paper P on which an image can be formed is 20,000 sets, the second calculation section 12 causes the operation section 2 to display a message indicating that the image formation is possible.

(2) In the above-described embodiment, the user determines whether or not to replace the toner container C, after step S103 and step S107. Note that the user may also determine whether or not to replace the toner container C, after step S101, step S102, or step S105.

(3) For example, in the above-described embodiment of the present disclosure, an example in which the image forming apparatus 100 is a multifunction peripheral has been described. Alternatively, the image forming apparatus 100 may, for example, be a photocopier or a printer.

What is claimed is:

1. An image forming apparatus comprising:
an attachment section to which a toner container is detachably attached, the toner container having first storage configured to store a first toner amount of toner contained in the toner container;
an intermediate hopper configured to accommodate the toner supplied from the toner container;
second storage configured to store a second toner amount of the toner contained in the intermediate hopper;
an image forming section configured to form an image on a sheet using the toner contained in the intermediate hopper;
a first calculation section configured to, in a case where an image is to be formed on a first predetermined number of the sheets, calculate a consumed toner amount that is the amount of toner consumed during formation of the image on a second predetermined number of the sheets, the second predetermined number being smaller than the first predetermined number; and
a second calculation section configured to calculate the maximum number of the sheets on which the image can be formed, on the basis of the consumed toner amount, the first toner amount, and the second toner amount.

2. The image forming apparatus according to claim 1, further comprising:
a display section,
wherein
the second calculation section calculates the maximum number of sets of the sheets on which the image can be formed, on the basis of the maximum number of the sheets on which the image can be formed, and the second predetermined number, and
the second calculation section causes the display section to display the maximum number of sets.

3. The image forming apparatus according to claim 2, wherein
the second calculation section reduces the maximum number of sets each time the image is formed on the second predetermined number of the sheets, and
the second calculation section causes the display section to display the reduced maximum number of sets.

4. The image forming apparatus according to claim 1, further comprising:
a display section; and
an input section configured to receive the desired number of sets on which the image is to be formed,
wherein
the second calculation section causes the display section to display a message indicating whether or not the image can be formed on the desired number of sets of the sheets, on the basis of the maximum number of the sheets on which the image can be formed, the second predetermined number, and the desired number of sets.

5. The image forming apparatus according to claim 1, further comprising:
a display section,
wherein
the second storage stores a first time it takes for the image forming section to form the image on a single piece of the sheet,
the second calculation section calculates a second time on the basis of the maximum number of the sheets on which the image can be formed and the first time,
the second calculation section causes the display section to display the second time, and
the second time indicates a time it takes for the image forming section to form the image on the maximum number of the sheets on which the image can be formed.

6. The image forming apparatus according to claim 5, wherein
the second calculation section reduces the second time each time the image is formed on a single piece of the sheet, and
the second calculation section causes the display section to display the reduced second time.

7. The image forming apparatus according to claim 1, further comprising:
a detector configured to detect replacement of the toner container,
wherein
when the toner container is replaced by another toner container, the second calculation section calculates the maximum number of the sheets on which the image can be formed, on the basis of the first toner amount of the other toner container, the second toner amount, and the consumed toner amount.
